(19) United States
(12) Patent Application Publication
(10) Pub. No.: US 2023/0078575 A1
(43) Pub. Date: Mar. 16, 2023

(54) Area Ventilation Devices, Systems, and Methods

(71) Applicant: Oy Halton Group Ltd., Helsinki (FI)

(72) Inventor: Andrey V. LIVCHAK, Bowling Green, KY (US)

(73) Assignee: Oy Halton Group Ltd., Helsinki (FI)

(21) Appl. No.: 17/801,713

(22) PCT Filed: Mar. 4, 2021
(86) PCT No.: PCT/US2021/020881

§ 371 Date: Aug. 23, 2022

Related U.S. Application Data
(60) Provisional application No. 62/984,868, filed on Mar. 4, 2020.

(51) Int. Cl. F24F 13/068; B60H 1/00; F24F 11/72; F24F 13/02

(52) U.S. Cl. CPC F24F 13/068; B60H 1/00364; F24F 11/72; F24F 13/0218; F24F 13/0272; F24F 2110/30

(57) ABSTRACT

One or more sections of a ventilated wall are provided around an outdoor space is not enclosed with a ceiling to form a fenced enclosure. Cooled air at a temperature colder than ambient temperature is supplied into the fenced enclosure through perforations in the wall and/or from an air-conditioned building adjacent to the fenced enclosure at displacement velocity to avoid disrupting stratification of air inside of the fenced enclosure. The cooled air pools inside of the fenced enclosure providing cooling for outdoor activities such as al fresco dining.

### CROSS-REFERENCE TO RELATED APPLICATIONS

This application claims priority to and the benefit of U.S. Provisional Patent Application No. 62/984,868 filed Mar. 4, 2020, which is hereby incorporated by reference in its entirety.

### BACKGROUND

Dining al fresco has become popular in restaurants. It would be a popular development if the season for dining al fresco despite the days when it is very hot or cold, diners could still be comfortable.

Displacement ventilation systems are known for cooling inside buildings, but not for cooling outdoor spaces.

### SUMMARY

An area cooling register which is simultaneously a ventilation duct and a partition is provided. In embodiments, the partition/duct is insulated on an outwardly-facing side thereof. In further embodiments, the partition/duct is of flexible fabric that inflates with ventilation air, which is diffused through openings in the partition duct.

According to further embodiments, the hollow structure is of flexible material. According to further embodiments, the flexible material is tethered to prevent ballooning of the hollow structure. According to further embodiments, the hollow structure is inflatable. According to still further embodiments, the hollow structure, once inflated, is free-standing. According to still further embodiments, the array of perforations discharges air at velocity of 100 fpm 10 diameters away from the wall such that the array forms a displacement register

Note that instead of the displacement diffuser covering the partition wall all the way to ground level, it can reach only part-way down the wall in further embodiments.

Note that an outdoor condensation unit of a packaged cooling system can be located outside the partitioned area behind the wall insulation allowing cool air to be generated wholly outside the restaurant or conditioned space with which the ventilated wall is associated.

One general aspect includes a partition plenum. The partition plenum also includes a hollow structure with an opening for admitting air that is cooler than ambient air. The plenum also includes and an array of perforations in a major face of said hollow structure that cause the air in the hollow structure to flow out of the hollow structure at a non-mixing air velocity.

Implementations may include one or more of the following features. The plenum where the hollow structure is of flexible material. The plenum may include: an internal inflatable support structure that provides a rigid frame when the support structure is filled with pressurized gas. The plenum is wound up into a roll when the plenum is not fully inflated with air. The flexible material is tethered to prevent ballooning of the hollow structure. Each of the perforations has a diameter d, and said array of perforations discharges air at velocity of 100 fpm when measured at a distance of 10 d away from the wall such that the array forms a displacement register. The hollow structure is made of a transparent material. The hollow structure is inflatable. The hollow structure, once inflated, is free-standing.

One general aspect includes a method of cooling an outdoor space. The method also includes providing one or more sections of a ventilated wall. The method also includes forming an enclosure from the one or more sections of the ventilated wall. The method also includes supplying cooled air into the one or more sections of the ventilated wall. The method also includes discharging the cooled air out of a permeable face of the one or more sections of the ventilated wall at a non-mixing air velocity, where. The method also includes the cooled air discharged at non-mixing air velocity does not disrupt stratification of air within the enclosure up to at least a height of the ventilated wall.

Implementations may include one or more of the following features. The method where the permeable face includes a plurality of holes. The permeable face includes an air permeable fabric. The method may include inflating the one or more sections of the ventilated wall to create a self-supporting structure. The forming an enclosure includes hanging the one or more sections of the ventilated wall on a support frame. The method may include: determining an air velocity at least at one of inside and outside of the enclosure; comparing the determined air velocity to a threshold velocity value; suspending the supplying of the cooled air if the determined air velocity is at or above the threshold velocity value. The method may include: restarting the supplying of the cooled air if the determined air velocity drops below the threshold velocity value. The threshold velocity value is an air velocity that disturbs stratification of air inside of the enclosure. The threshold v

One general aspect includes a method of providing a mobile cooled space. The method also includes providing a mobile platform to which a mobile cooling wall is attached. The method also includes deploying the mobile cooling wall which includes at least one hollow wall section. The method also includes discharging air colder than an ambient temperature at displacement air velocity from at least one of the mobile platform and the hollow wall section.

Implementations may include one or more of the following features. The method where the mobile cooling wall forms a fence enclosure when it is deployed. The deploying of the mobile cooling wall includes inflating the at least one hollow wall section with air. The mobile platform includes one or more displacement registers. The mobile platform includes a gate configured to close off the fence enclosure formed by the mobile cooling wall. The method may include: sealing the space underneath the mobile platform to prevent airflow underneath the mobile platform when the mobile cooling wall is deployed. The mobile platform includes a road going vehicle.

One general aspect includes a vehicle with a cooled external space. The vehicle also includes a source of cooled air that generates cooled air at a temperature lower than an ambient temperature. The vehicle also includes a mobile cooling wall deployable from the vehicle.

Implementations may include one or more of the following features. The vehicle may include: one or more displacement registers configured to discharge the cooled air at a displacement of velocity. The vehicle may include: a curtain, a skirt, and or an inflatable partition that prevents or reduces airflow underneath the vehicle when the mobile cooling wall is deployed. The mobile cooling wall includes at least one inflatable wall section. The at least one inflatable wall section includes perforations that permit air to flow out of the inflatable wall section at displacement velocity. The vehicle may include: a gate operable to open and close an enclosure formed by the deployment of the mobile cooling wall. The vehicle is a food truck. The vehicle when the vehicle includes a window facing toward the inflatable wall when the inflatable wall is deployed.

One general aspect includes a cooled seating structure in an ambient temperature environment. The cooled seating structure also includes a plenum that conveys cooled air colder than the ambient temperature. The structure also includes a fluid connection between the plenum and a hollow seating structure, where the hollow seating structure includes a seating surface.

Implementations may include one or more of the following features. The cooled seating structure where the plenum includes a perforated wall. Air flows out of perforations in the perforated wall at a displacement velocity in a direction toward the seating surface. The seating surface is made of a material that conducts thermal energy and provides a cooling effect to an object on top of the seating surface. The cooled seating structure may include: a ventilated base wall below the seating surface and having perforations that emit the cooled air at displacement air velocity.

One general aspect includes a method of extending air-conditioned space from an air-conditioned building to an external area that is not covered by a ceiling. The method of extending air—conditioned space also includes enclosing the external area with a fence that prevents airflow underneath the fence. The space also includes discharging cooled air at a temperature colder than ambient temperature into the enclosed external area at a displacement air velocity.

Implementations may include one or more of the following features. The method where the enclosing includes deploying of inflatable ventilated wall. The inflatable ventilated wall includes at least one perforated face that includes a plurality of openings that permit air from inside of the inflatable ventilated wall to discharge at the displacement air velocity. The deploying includes inflating the inflatable ventilated wall with a source of pressurized air. The discharging the cooled air includes supplying the cooled air into the enclosed external area through a displacement air register from the air-conditioned space. The discharging of the cooled air includes supplying the cooled air into the enclosed external area through a door that connects the air-conditioned space to the external area. The discharging of the cooled air includes supplying of the cooled air into the enclosed external area through a window that connects the air-conditioned space to the external area. The cooled air is generated by a cooling device that provides cooled air for air conditioning of the air-conditioned space. The cooled air is generated by a cooling device that it does not provide air for the air conditioning of the air-conditioned space.

One general aspect includes a system for cooling an outdoor space. The system also includes an air-conditioned enclosed building. The system also includes an outdoor space that is not enclosed by a ceiling, adjacent to the air-conditioned enclosed building. The system also includes a ventilated wall surrounding the outdoor space and configured to supply cooled air at a temperature colder than ambient air into the outdoor space at a displacement air velocity.

Implementations may include one or more of the following features. The system where the cooled air supplied at the displacement air velocity does not disrupt stratification of air inside of the outdoor space that is surrounded by the ventilated wall. The system may include: a cooling device that is configured to generate air at a temperature colder than ambient air temperature. The ventilated wall is made of a rigid material. The ventilated wall is made of a soft and/or flexible material. The ventilated wall is inflated with a gas in order to hold its final shape. The ventilated wall includes a plurality of wall sections connected to each other with air connections. The ventilated wall includes an internal inflatable structure. The ventilated wall includes internal ribs that hold the inflatable wall in its final shape when the inflatable wall is inflated with the gas.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Some of the figures may have been simplified by the omission of selected features for the purpose of more clearly showing other underlying features. Such omissions of elements in some figures are not necessarily indicative of the presence or absence of particular elements in any of the exemplary embodiments, except as may be explicitly disclosed in the corresponding written description.

FIG. 1 shows a displacement register that acts as a partition and a displacement register, where the partition has holes in a side facing diners in an area according to embodiments of the disclosed subject matter.

FIG. 2A shows an aerial view of a patio that is fenced-in by the apparatus of the disclosed subject matter according to embodiments of the disclosed subject matter.

FIG. 2B shows an aerial view of the patio that is fenced in and includes separating cooling partitions, according to embodiments of the disclosed subject matter.

FIG. 3 shows a frontal view of a displacement register partition suspended on a frame, according to embodiments of the disclosed subject matter.

FIG. 4 shows an aerial view of an area cooled by a ventilated partition, according to embodiments of the disclosed subject matter.

FIG. 5 shows a close-up view of the joint of two ventilated walls joined together, according to embodiments of the disclosed subject matter.

FIG. 6A shows an example of a flexible inflatable ventilated wall rolled up, according to embodiments of the disclosed subject matter.

FIG. 6B shows an example of an internal support structure of a flexible inflatable ventilated wall, according to embodiments of the disclosed subject matter.

FIG. 7A shows an example of an air-conditioned structure sharing its cooled air with an enclosed area surrounded by a ventilated wall, according to embodiments of the disclosed subject matter.

FIG. 7B shows aerial view of an air-conditioned structure sharing its cooled air with an enclosed area surrounded by a ventilated wall, according to embodiments of the disclosed subject matter.

FIG. 8A shows an example of a cooled bench according to embodiments of the disclosed subject matter.

FIG. 8B shows another example of a cooled bench according to embodiments of the disclosed subject matter.

FIG. 9A shows an example of a mobile cooled area according to embodiments of the disclosed subject matter.

FIG. 9B shows an aerial view of the embodiment of FIG. 9A.

FIG. 10 shows an example of a processing flow according to embodiments of the disclosed subject matter.

FIG. 11 shows an example of the hardware configuration of a processor that implements the processing according to various embodiments of the disclosed subject matter.

### DETAILED DESCRIPTION

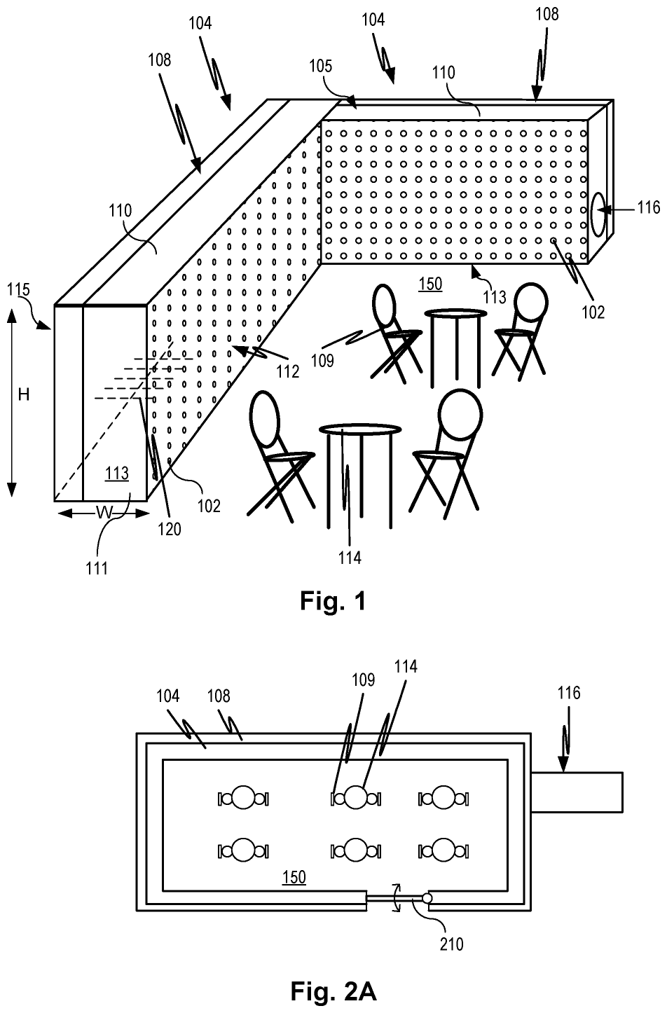

Referring now to FIG. 1, a patio 150 is walled-in by a partition 104 that surrounds the patio 150. The present disclosure will refer to partition 104, ventilated partition 104, inflatable partition 104, ventilated wall 104, and cooled wall 104, interchangeably, according to surrounding context. Two tables 114 and four chairs 109 are shown. The partition 104 is hollow such that it has in internal cavity that can convey air and has one or more perforated walls 112 that function as a displacement diffuser. FIG. 1A illustrates only two walls of partition 104, but as will be shown below, the layout of the partitions is not limited to an L-shaped, but instead can be a fence (e.g., rectangular, square, circular, polygon, or oval), that encloses a space. The partition can act as a container for cooled air that by virtue of its temperature (cold air density is higher than warm air) pools near the ground, below the walls of the partition. The cooled air has a very low velocity at which stratification of the air is maintained. Thus, in some embodiments the perforated walls 112 can be omitted, as long as cooled air is conveyed into the area enclosed by the partition at non-mixing air velocity (i.e., displacement velocity), such that stratification of the air inside of the enclosed space is maintained. In embodiments, this is achieved by providing an air conditioning device that may be inside or outside of the enclosure, and that conveys cooled air into the enclosure with one or more displacement registers, that emit air at displacement velocity (i.e., non-mixing velocity).

The height of the partition (H) determines the depth of the cooled region surrounded by the partition. The partition can have an array of perforations or holes 102 on a surface 112 thereof. A first part of the partition that functions as a plenum 105 may be insulated by an insulated portion 108 facing away from the tables 114 and chairs 109, but in some embodiments the insulated portion 108 is omitted. A cool air inlet is indicated at 116, and a cooling device provides a stream of cool air into the air inlet. Cooled air is forced out of the plenum through perforated wall 112 at a low rate of speed and thus doesn't mix with the surrounding air. As a result the cool air floods the enclosed spaced defined by the partition.

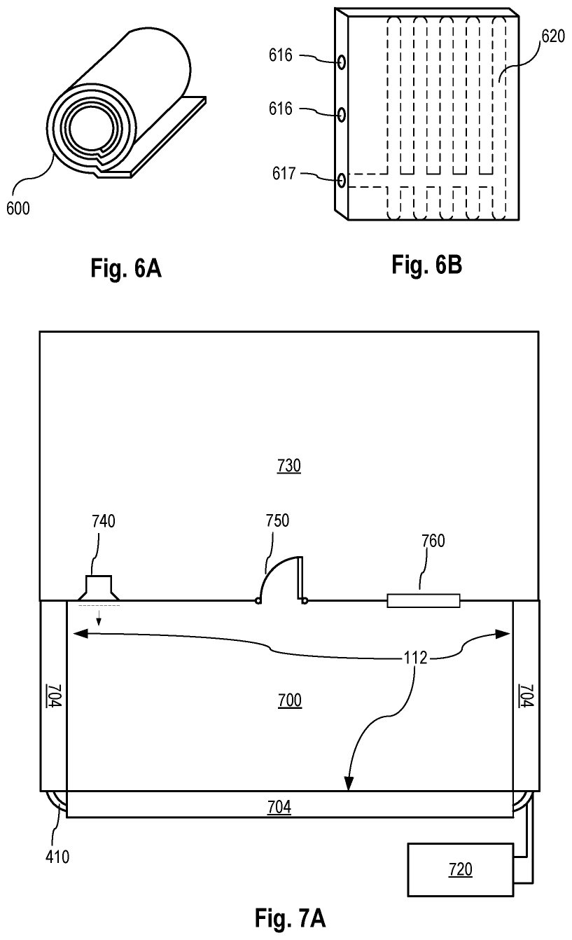

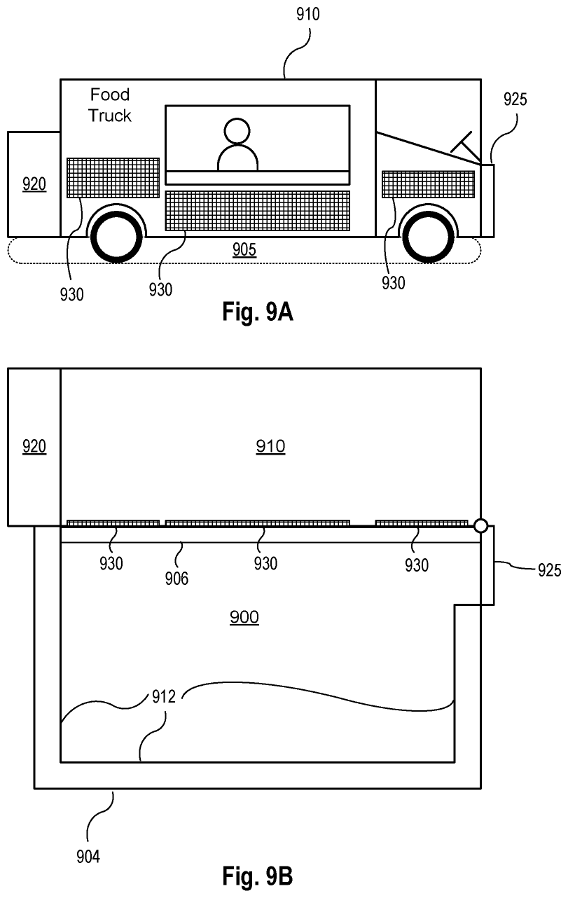

The partition 104 in FIG. 1 is not drawn to scale. More specifically, in an embodiment it is envisioned that the width of the partition (W) is significantly smaller than the height (H) of the partition. In an embodiment, the height of the partition is 4 feet. In another embodiment the partition height is 3 feet. In any of the disclosed embodiments, the width can be 1 cm, 2 cm, 3 cm, 5 cm, 6 cm, 7 cm, 8 cm, and greater. In an embodiment where the width is substantially smaller in the height, for example where the width is 2 cm and the height is 4 feet, it is possible to construct an inflatable partition 104 that rolls up similarly to common floormat and can be easily stored when not needed, such as illustrated in FIG. 6A. This type of construction makes the ventilated partition transportable, such that it can be retrofitted easily at existing locations, or it can be mounted to a mobile platform, such as a food truck as shown in FIG. 9A. Moreover, this aspect ratio of the partition is aesthetically pleasing and does not take away valuable floorspace from the dining patio 150. In embodiments, the entire partition 104 is constructed from multiple types of fabric. The perforated wall 112 can be constructed from a permeable fabric, while the other surfaces are constructed from a non-permeable fabric joined to the permeable fabric.

Referring again to FIG. 1, the partition 104 includes an end wall 111, a top wall 110, a perforated side wall 112, a bottom wall 113, and a solid side wall 115. The perforated side wall 112 may include a plurality of holes 102 as shown in the figure. Holes 102 may be formed in the perforated side wall 112 with a mechanical punch or other drilling methods that provide a controlled a hole size. However, in embodiments, the perforated wall 112 may be made of a permeable fabric which is woven in such a way that air can readily pass through the fabric because of the weaving pattern and style, and omit specific holes 102.

On the other hand, the other walls 110, 111, 113, and 115 are formed from a material that is not permeable to air. This material can be a rigid in case of a permanent installation of partition 104, or it may be flexible or semirigid in embodiments where the partition 104 is more easy to store, such as by rolling up.

In embodiments, the partition 104 can be made from a transparent or translucent material which will avoid blocking a view from the patio 150, while still providing a cooling effect. In an embodiment, all of the walls 110, 111, 112, 113, and 115 are formed from glass, Plexiglas, acrylic, or another type of polymer. The different walls do not have to be formed from the same material, and can be formed from different materials. In a particular embodiment, all of the walls are formed from acrylic, thus providing a transparent view while allowing cooling. In this embodiment, holes 102 can be formed in the acrylic of perforated side wall 112 by drilling, mechanical punching, laser engraving, or other methods. As will be understood, when the ventilated wall is constructed from a rigid material, the rigid material will support the structure of the ventilated wall even when there is no air being supplied to the ventilated wall. On the other hand, when the ventilated wall is constructed from a soft, flexible or semiflexible material that cannot support its own weight, there are various ways provided for supporting the ventilated wall. For example, as illustrated in FIG. 3 and discussed below, the ventilated wall can be suspended from a frame. In other embodiments, the ventilated wall can be provided with internal support structures such as ribs 620 illustrated in FIG. 6B and described below.

The perforated wall 112 is illustrated with holes 102 along its entire height. However, this illustrated example is not limiting, and in some embodiments, the perforations are only provided along the lower portion of the wall. In an embodiment, the perforations are provided along the lower one quarter of the wall. In another embodiment, the perforations are provided along the lower one third of the wall. In another embodiment the perforations are provided along the lower one half of the wall. As described herein, by providing the cooled air at a low velocity, which maintains stratification of the air inside of the enclosure, it is possible to fill up the enclosure with cold air much like a pool with water. Cold air is heavier than warm air, and will displace warm air that is in the enclosure and force that warm air upward as the cold air settles at the bottom of the enclosure.

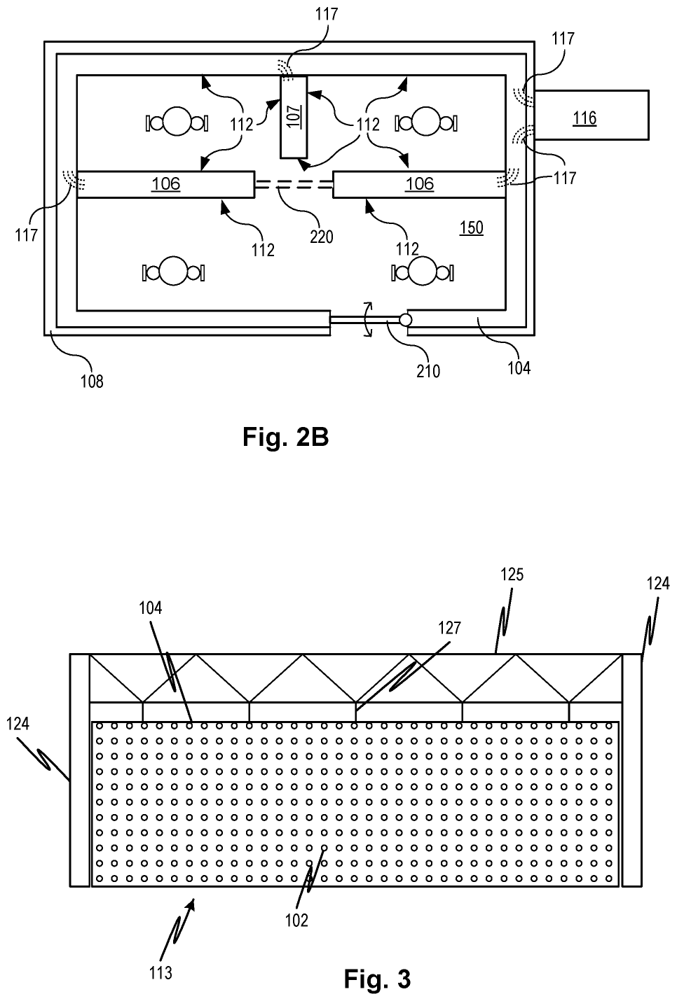

Referring now to FIG. 2A, an overhead view of a patio with tables 114 and chairs 109. The patio is surrounded by ventilated walls 104 (optionally with insulation 108) and defining a plenum 105 inside the ventilated walls. One side of the patio may be bounded by a fixed structure such as a restaurant front. A source of cool air may pressurize the plenum to make it stand or a different source of ambient air may be used to inflate a further bladder (e.g. 620 in FIG. 6B) inside the partition walls to make them erect. In embodiments the walls of the inflatable partition have tethers 120 inside to prevent the partition from ballooning outwardly. The tethers 120 may be arrayed over the face of the plenum to make it roughly of uniform depth after inflation.

Referring still to FIG. 2A, a gate 210 is shown as closing the inflatable partition 104 as it is formed around a patio 150. By providing a gate 210, it is possible to completely enclose the patio 150 such that the inflatable partition 104, with the gate 210 effectively forms a pool inside of which cold air can collect and pool near the ground and slowly rise up by virtue of additional cold air being supplied through the perforated wall 112. As will be described below, this is possible due to the displacement of velocity principle.

A cold air inlet 116 is a shown in FIGS. 1 and 2A. The cold air 116 inlet can be connected via a duct or directly to a source of cold air, such as an air conditioning unit or a Peltier cooling unit. In embodiments, the cold air inlet may be omitted, and a cooling unit can be installed directly inside of the inflatable partition 104. It will be understood that in such an embodiment, the width W of the inflatable partition has to be sufficient to accommodate such a cooling device.

Referring now to FIG. 2B, the same arrangement as shown above in FIG. 2A is shown, but additional dividing walls 106 and 107 are provided. It will be understood that the specific configuration in FIG. 2B is not limiting and multiple dividing walls 106 and 107 may be provided at different locations to divide the patio 150 into multiple regions, each being cooled. Dividing wall 106 is similar to the inflatable partition 104 however it differs in that the dividing wall 106 has two opposed perforated walls 112, as shown in FIG. 2B. In other words, cooled air is provided out of two opposed walls, as opposed to only one. In an embodiment, the end wall 113 of the dividing wall 107 can also be perforated, as shown in FIG. 2B. In other words, partition 107 has three perforated walls 112. As shown in all of the embodiments above, the general cross-section of the inflatable partition 104 and of the dividing wall 106 can be rectangular. However, in other embodiments the cross-sectional shape may have other shapes, such as triangular, V-shaped, or oval. Still referring to FIG. 2B, an optional gate 220 is shown with dashed lines. The provision of an additional gate allows completely separating certain areas within the cooled enclosure, to control individual temperature in each enclosed section. It will be understood that the space surrounded by the ventilated walls 104 does not have a roof or ceiling above it, so it is open to the outside environment from above.

As can be seen in FIG. 2B, the dividing walls 106 and 107 are provided with air connections 117, as shown by dashed lines in the figure. This illustrates the concept that entire ventilated wall structure is modular, and it is envisioned that the ventilated walls 112 are provided with one or more connection ports which allow the attachment of partition walls at the location and time needed.

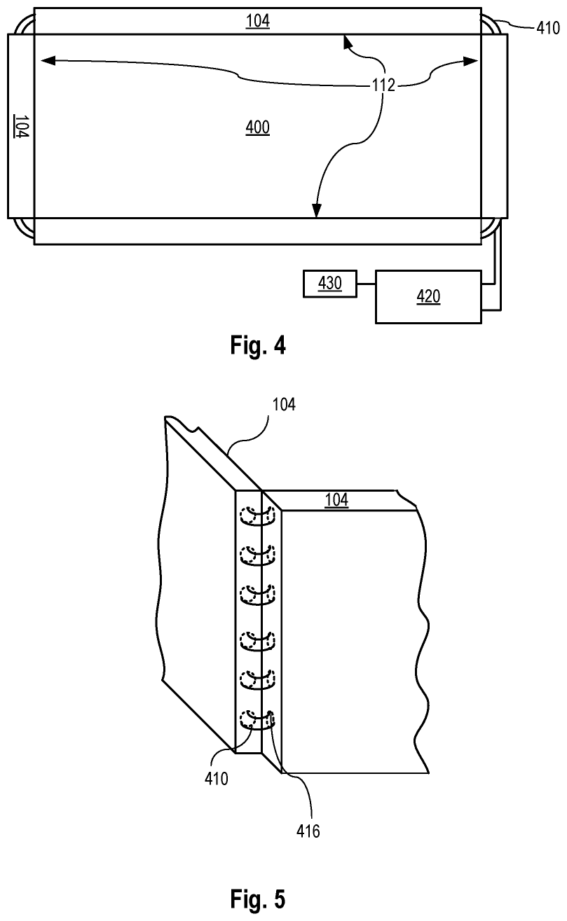

Referring to FIG. 3, in an alternate embodiment, the ventilated partition 104 is shaped as a low profile, flexible wall that is suspended or hung from a support frame. This can be thought of as an inflatable curtain suspended from a support frame. As shown in FIG. 3, the support frame may be formed from a truss 125 that serves as a horizontal crosspiece that is supported by columns 124. The truss 125 may be directly connected to the inflatable partition 104 or by tethers 127. The truss and columns may be provided to help keep the partition from being blown away by air currents. It will be understood that the FIG. 3 shows a single portion of the inflatable partition 104, but the disclosure is not limited to such a single portion. For example, a rectangular enclosure can be formed from four partitions 104, such that when the four partitions are placed adjacent to each other, and enclosed area results. An example of this is illustrated in FIG. 4.

Referring now to FIG. 4, a top view of cooled area 400 is shown. Four individual inflatable partitions 104 are placed around the outer perimeter of cooled area 400, and are connected to each other with connection pipes 410 that fluidly connect inlet openings 416. As will be understood, all embodiments of inflatable partitions 104 can be used in this arrangement. Therefore, the support frame of FIG. 3 is not illustrated, but it is understood that it could be present in this embodiment. As shown in FIG. 5, which shows a side view of a joint between two adjacent inflatable partitions 104, there may be multiple connection pipes 410 connecting the individual inflatable partitions 104. As further shown in FIG. 4, a cooled air source connection 420 may be provided at one or more locations to provide a cooled air via the inlet's that are connected through connection pipes 410.

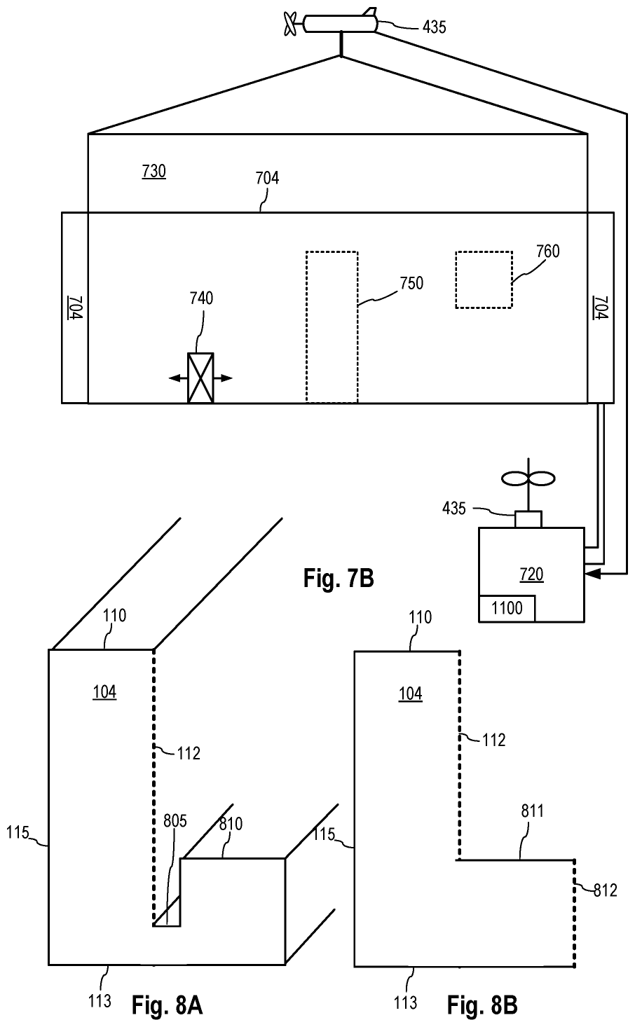

Still referring to FIG. 4, a speed sensor 430 is operatively connected to the source of air 420. The speed sensor 430 provides information about air speed inside and/or outside of the enclosure to a process that performs a control routine according to various embodiments. So despite being shown outside of the space 400, speed sensor 430, or additional speed sensors may be provided inside of the space 400 to measure air velocity within the space 400. The speed sensor(s) provide data to a controller may be implemented as a general purpose processor as shown in FIG. 11. The speed sensor 430 may be implemented as a weathervane with a propeller as shown at 435 in FIG. 7B.

The present disclosure uses of the term displacement air velocity, to differentiate it from mixing velocity. Displacement ventilation (DV) is an air distribution strategy where conditioned air is supplied at a low velocity from air supply diffusers located near floor level and extracted above the occupied zone. In the disclosed embodiments of the present disclosure, the conditioned air is supplied from perforated walls 112 of the inflatable partition(s) 104 at a velocity that is a sufficiently low that the air merely displaces existing air in the space, without creating turbulent flow or drafts. Turbulent flow could cause the cooled air to escape out specifically above and over the wall height of the inflatable partition 104. More specifically, by using displacement velocity, it is possible to maintain stratification of air due to temperature. In embodiments, air is provided through perforated wall 112 at a velocity that maintains stratification of air in the area bounded by the inflatable partition 104. Generally speaking, displacement cooling ventilation can be made quieter and more efficient because the airflow is low and will not generate much sound, and the cooled air is not wasted as it pools along the ground and then rises to fill up the enclosure formed by inflatable partition 104. As is further described below, a control system and method is disclosed to take advantage of displacement ventilation principles and to control the system in response to external air velocity, such as caused by outside wind or drafts that would disrupt displacement ventilation.

Cooled air is provided through perforated wall 112 to the space bounded by inflatable partition 104 and in some cases dividing wall 106 at displacement air velocity. Because the air is provided at displacement velocity, stratification of the air inside the bounded space is maintained, and the cool air pools near the floor, and then arises as additional cooled air is provided through perforated wall 112. Eventually, the entire volume that is bounded by inflatable partition 104 is filled with cooled air, and the cooled air spills out over the top edge of the inflatable partition 104. This is acceptable, because the height (H) of the inflatable partition 104 is selected such that occupants of the enclosed space such as diners sitting in a chair 109, will be mostly inside of the cool stratified air before it spills out over the partition 104.

To provide uniform air distribution along the entire length of the cooling wall made by one or more inflatable partitions 104, it is desirable to provide a sufficient pressure drop between the inlet 116 in the area where air will exit the wall. This is accomplished by selecting an appropriate airflow rate into inlet 116 and also selecting the permeability of the perforated wall 112 (or the size and number of holes 102 in the wall).

In an embodiment, the ventilated partition 104 is inflatable. In other words, it can be constructed from a soft flexible and partially stretchable material, as opposed to being rigid.

Turning next to FIG. 6A, a ventilated wall is wound or rolled up as roll 600. It will be understood that in this embodiment, the entire ventilated wall is flexible enough to be rolled up. This may be achieved by using a flexible or semirigid outer wall 115, coupled with a permeable fabric forming the ventilated wall 112. Although not illustrated in FIG. 6A, it will be understood that the roll 600 as shown can be connected with other pieces or rolls 600 via the ports 616 and 617, which are shown in FIG. 6B.

Referring now to FIG. 6B, a section of the ventilated wall is shown with an internal support structure 620. The internal support structure 620 can be formed from inflatable ribs which are shown in a dashed lines. The inflatable support structure 620 is provided with its own dedicated inlet port 617, as shown in the figure. Other inlet ports 616 are shown. It will be understood, that ports 616 are intended to receive cooled air, while the inlet 617 can be supplied with regular, uncooled air as the purpose of the inlet 617 is to provide a support structure, rather than a cooling function. Even though two inlet ports 616 a single inlet ports 617 are shown in FIG. 6B, this arrangement is not limiting, and there may be multiple inlet ports 617 provided and a different number of inlet ports 616 provided indifferent embodiments.

Referring now to FIG. 7A, an enclosed air-conditioned space 730 can be extended by using inflatable or ventilated wall partitions 704 as shown. In this embodiment, an air-conditioned building 730 has a door at 750 and window 760. It may also have one or more displacement air registers 740. FIG. 7A shows an aerial view of such a building with an open space 700 outside of the building. A ventilated fence is built around the space 700, but it will be understood that area 700 does not have a roof or ceiling above it, such that the walls 704 are not closed at the top. This is illustrated schematically in FIG. 7B. In this embodiment, the wall 704 may be a ventilated such that it would have the ventilated walls 112, as shown in FIG. 7B. However, in an embodiment, one or more of the ventilated walls 112 are omitted, such that the wall partitions 704 only provide a fence and enclose function, while the cooled air is provided only from the building 730 by one or more of register(s) 740, door 750, and window(s) 760. When the ventilated walls 112 are provided, the ventilated wall partitions 704 are connected with air connections 410 as shown. A source of additional conditioned air 720 may be provided.

In embodiments, air source 720 may provide only pressurized air, without any air-conditioning. This would be advantageous, for example, if wall 704 is not rigid and is inflatable, such that air source 720 provides pressurized air to keep wall 704 inflated, while the conditioned air is provided from the conditioned space 730. In this scenario, when door at 750 is opened, conditioned air can leave the conditioned space 730 and flow into the enclosed area 700. Similarly, one or more displacement registers 740 may be provided, at a horizontal level below the top of the wall 704, such that conditioned air from space 730 flows into the enclosed space 700. Similarly, one or more windows 760 may be used for this purpose.

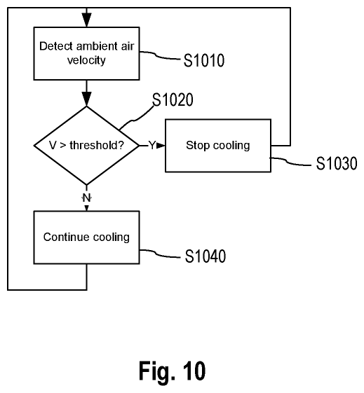

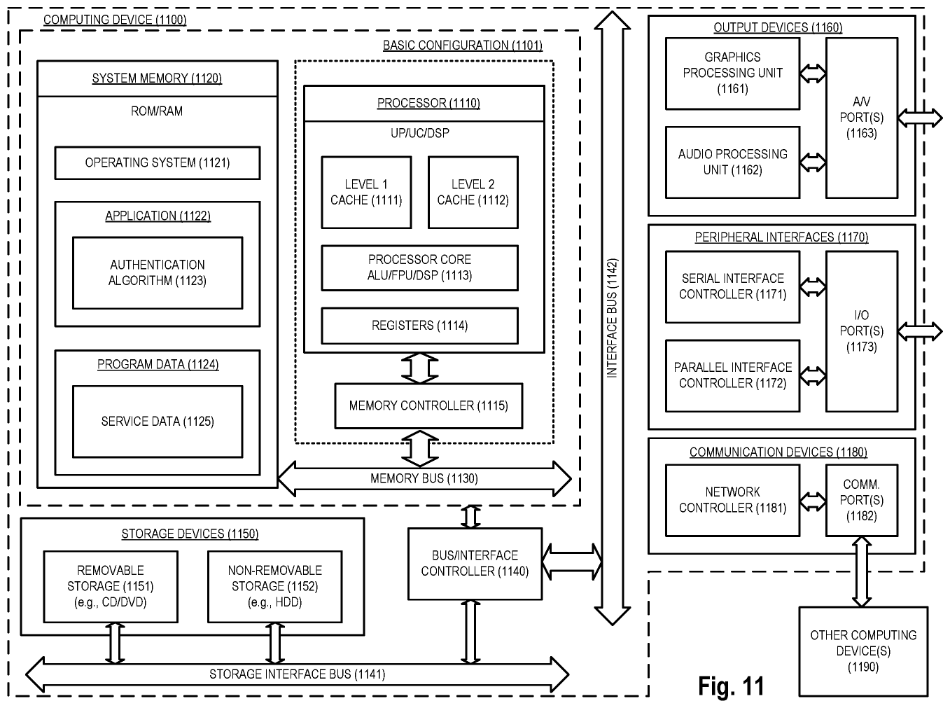

Referring now to FIG. 7B, a side view of the arrangement of FIG. 7A is shown. In FIG. 7B, air velocity sensors 435 are shown. There may be one or more such air velocity sensors provided to detect ambient air speed at various locations relative to the enclosed space 700. In an embodiment, a velocity sensor is provided inside of the enclosed space 700, to measure the air velocity inside of the space. If the air velocity inside of the enclosed space 700 is above a threshold airspeed, it can be assumed that the stratification of the air inside of the enclosed based 700 has been disrupted and that the cooling effect is no longer provided. On the other hand, in this situation, it can be expected that the airflow which disrupted of the stratification is also providing cooling to the occupants within the enclosed space 700. Thus, it may be desirable to turn off or reduce the cooling in such a situation, to avoid wasting energy when cooling is provided by the ambient air velocity and when that air velocity disrupts the cooling effect of a ventilated wall. The processing to achieve this can be implemented on a controller 1100 illustrated in FIG. 7B. The controller 1100 can be implemented in various forms of hardware, including that illustrated in FIG. 11. A process flow that can be implemented by controller 1100 is described below with reference to FIG. 10.

Referring now to FIGS. 8A and 8B, an extension of the ventilated wall 104 can create ventilated benches 810 and 811. In FIG. 8A, the bench is shown in profile and may be of any width. In FIG. 8B, only a cross-sectional view is shown. The bench 810 has a seating surface and a backrest which may be formed from the ventilated wall 112. The seating surface of the bench 810 can be also air permeable to provide extra cooling, and/or it may be made of a thermally conductive material that permits the cooled air inside of the bench to cool the outer surface of the seating area. Referring to FIG. 8A, the bench 810 can be an additional module that is retrofitted or attached to ventilated wall 104, and connected to the wall with a connection conduit 805. This allows for a customized layout of a seating area that utilizes a standardized ventilated wall 104, to which the ventilated bench 810 is added where and when needed. It will be understood that the connection conduit 805 can connect to inlet openings (not illustrated) which are positioned along the bottom edge of ventilated wall 104.

Referring to FIG. 8B, in an embodiment the ventilated bench 811 is integrally attached to ventilated wall 104, thus omitting the connection conduit 805. In an embodiment, the front wall 812 of the bench 811 may be perforated as shown by dashed lines in FIG. 8B. In this case, the perforated front wall 812 provides additional cooling effect. Further, the cool air circulates inside of the bench and also keeps it cool without holes, thus providing further cooling.

It will be understood that the embodiments of FIG. 8A and FIG. 8B can be modified, such that features from one can be incorporated into the other. For example, bench 810 may also be provided with a ventilated front wall 812, even though it is not illustrated. The benches may be constructed out of a rigid material, or may in some embodiments be made out of a soft and/or flexible material and be inflatable themselves to provide a compliant seating area that is supported by pressurized air inside of the bench.

In another embodiment, a food service a vehicle 910, commonly known as a “food truck,” can apply the principles described herein. In an exemplary embodiment, the food truck may have a an external surface which includes one or more displacement registers 930 which provide cooled air at displacement velocity, as shown in FIG. 9A. The displacement registers 930 may be vents which open and close to the interior of the vehicle 910 which is air conditioned inside, such that the conditioned air can flow out of the registers 930. In an embodiment, a separate cooling system is provided to supply cooled air through the registers 930 separately from any air conditioning that may take place inside the vehicle. In either case, the cooled air is supplied at displacement velocity.

As shown in FIG. 9A, in an embodiment, the vehicle 910 also includes a portable cooling wall 920 and a gate 925. FIG. 9 a shows a side view of the vehicle 910 with the portable cooling wall 920 in its stowed position that would normally be used for transport. FIG. 9B shows an overhead view of the vehicle 910 with the portable cooling wall 920 deployed. The portable cooling wall 920 can be a ventilated wall according to any of the disclosed embodiments, and includes one or more sections of wall 904 as shown in the figure. Even though wall 904 is illustrated in FIG. 9B as a single piece, it will be understood that the wall can be made up of individual sections which are joint together as described above. One or more portions of the wall 904 may include a perforated face 912. It will be understood that only some of the sections of wall 904 might be perforated while others are solid. The portable cooling wall 920 may include a cooling device which provides pressurized cooled air into the hollow interior of the wall 904 and thereby provide displacement flow of cooled air through perforations in perforated face 912.

Referring now to FIG. 9B, a cooled area 900 can be formed when the vehicle 910 is parked and the portable cooling wall 920 is deployed. When gate 925 is closed as a shown in FIG. 9B, a space is enclosed by one side of the vehicle 910 and 3 sides of the wall 904. When cooled air is provided through one or more of displacement registers 930 and perforated faces 912, the cooled air pools inside of the enclosed space providing cooling for patrons of the food truck who are inside of area 900. To minimize or avoid a leakage of cooled air through the space under the vehicle 910, the vehicle 910 can be further equipped with a bottom curtain 905 which hangs from the undercarriage of the vehicle (shown in dashed line) and seals the space underneath the vehicle when the portable cooling wall 920 is deployed. In other embodiments, the curtain 905 may include an inflatable bag to seal of the space. In another embodiment, curtain 905 may hang from the side of the vehicle 910 and be lowered into position when the wall 904 is deployed. In yet another embodiment, the portable cooling wall 920 may contain a wall section 906 that is an extension of wall 904 and sharing a fluid connection therewith, extending along the side wall of vehicle 910, at a height that is sufficient to block the space under the vehicle. In this example, the additional wall section 906 of wall 904 may be perforated to provide a cooled air instead or in addition to displacement registers 930.

In an embodiment, food service station, such as a bar that is used for serving drinks, may be provided with a ventilated wall that provides cooling according to any of the embodiments described herein. More specifically, a bar includes a supporting wall which holds a bar top surface. The supporting wall may have a front surface and one or more side surfaces. The wall may be made hollow and supplied with cooled air such that the surface of the wall becomes cold to the touch due to the flow of cooled air. Further, a displacement velocity register can be installed on the front surface, or the entire front surface, or portions thereof, may be perforated such that displacement velocity flow of cooled air is provided from the front surface. This will provide a cooling effect to any patrons standing or sitting in the vicinity of the front wall. In addition, a walled off section can be installed surrounding the bar front surface, such that the bar front surface, together with other walls forms an enclosure such as 104, 704, 904 described above.

Referring now to FIG. 10, the controller is configured to determine wind speed of the ambient environment at S1010, and perform various steps in response to that wind speed. In an embodiment, when the wind speed is above a 1^{st} threshold at S1020, it may be determined that the ambient wind speed is sufficient to provide cooling for people in the dining area, and thus no supplemental cooling is needed. In this scenario, the controller may turn off the source of cooling, such as an air conditioner, or a Peltier cooling device at S1030. Otherwise, the cooling may continue at S1040, with the process repeating. It will be understood that if the cooling wall is inflatable, a fan may remain turned on to provide pressurizing air for the inflatable wall even when cooling is turned off.

It will be understood, that in the present disclosure, when a cooling device is disclosed, it may be any type of a cooling device that reduces the temperature of air. Examples include, Peltier cooling devices and compression cycle refrigeration devices. This also contemplated, that a large surface heat exchanger can be formed from the actual surface of the cooling wall such that natural radian cooling effect takes place to cool air that passes through the interior of the ventilated wall 104.

FIG. 11 is a block diagram illustrating an example computing device 1100 that is configured for controlling a ventilated wall for al fresco dining according to embodiments of the present disclosure. In a very basic configuration 1101, computing device 1100 typically includes one or more processors 1110 and system memory 1120. A memory bus 1130 can be used for communicating between the processor 1110 and the system memory 1120.

Depending on the desired configuration, processor 1110 can be of any type including but not limited to a microprocessor (μP), a microcontroller (μC), a digital signal processor (DSP), or any combination thereof. Processor 1110 can include one more levels of caching, such as a level one cache 1111 and a level two cache 1112, a processor core 1113, and registers 1114. The processor core 1113 can include an arithmetic logic unit (ALU), a floating point unit (FPU), a digital signal processing core (DSP Core), or any combination thereof. A memory controller 1115 can also be used with the processor 1110, or in some implementations the memory controller 1115 can be an internal part of the processor 1110.

Depending on the desired configuration, the system memory 1120 can be of any type including but not limited to volatile memory (such as RAM), non-volatile memory (such as ROM, flash memory, etc.) or any combination thereof. System memory 1120 typically includes an operating system 1121, one or more applications 1122, and program data 1124. Application 1122 includes ventilation control algorithm 1123 that is arranged to implement a control flow as shown in FIG. 10, but is not limited to that particular implementation and variations of the control algorithm are contemplated and embraced by the present disclosure. Program Data 1124 includes various wind threshold data 1125 that is useful for determining in step S1020 whether to stop cooling, as will be further described below. In some embodiments, application 1122 can be arranged to operate with program data 1124 on an operating system 1121. This described basic configuration is illustrated in FIG. 11 by those components within dashed line 1101.

Computing device 1100 can have additional features or functionality, and additional interfaces to facilitate communications between the basic configuration 1101 and any required devices and interfaces. For example, a bus/interface controller 1140 can be used to facilitate communications between the basic configuration 1101 and one or more data storage devices 1150 via a storage interface bus 1141. The data storage devices 1150 can be removable storage devices 1151, non-removable storage devices 1152, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1120, removable storage 1151 and non-removable storage 1152 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media can be part of device 1100.

Computing device 1100 can also include an interface bus 1142 for facilitating communication from various interface devices (e.g., output interfaces, peripheral interfaces, and communication interfaces) to the basic configuration 1101 via the bus/interface controller 1140. Example output devices 1160 include a graphics processing unit 1161 and an audio processing unit 1162, which can be configured to communicate to various external devices such as a display or speakers via one or more A/V ports 1163. Example peripheral interfaces 1170 include a serial interface controller 1171 or a parallel interface controller 1172, which can be configured to communicate with external devices such as input devices (e.g., keyboard, mouse, pen, voice input device, touch input device, etc.) or other peripheral devices (e.g., printer, scanner, etc.) via one or more I/O ports 1173. An example communication device 1180 includes a network controller 1181, which can be arranged to facilitate communications with one or more other computing devices 1190 over a network communication via one or more communication ports 1182. The communication connection is one example of a communication media.

Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 1100 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1100 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It is, thus, apparent that there is provided, in accordance with the present disclosure, area ventilation devices, systems, and methods. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1. A partition plenum, comprising:
a hollow structure with an opening for admitting air that is cooler than ambient air;
and an array of perforations in a major face of said hollow structure that cause the air in the hollow structure to flow out of the hollow structure at a non-mixing air velocity.

2. The plenum of claim 1, wherein the hollow structure is of flexible material.

3. The plenum of claim 2, further comprising:
an internal inflatable support structure that provides a rigid frame when the support structure is filled with pressurized gas.

4. The plenum of claim 2, wherein
the plenum is wound up into a roll when the plenum is not fully inflated with air.

5. The plenum of claim 1, wherein the hollow structure is made of a transparent material.

6. The plenum of claim 2, wherein the flexible material is tethered to prevent ballooning of the hollow structure.

7. The plenum of claim 1, wherein the hollow structure is inflatable.

8. The plenum of claim 7, wherein the hollow structure, once inflated, is free-standing.

9. The plenum of claim 2, wherein
each of the perforations has a diameter D, and
said array of the perforations discharges air at velocity of 100 fpm when measured at a distance of 10 D away from the major face such that the array of the perforations forms a displacement register.

10-38. (canceled)

39. A method of extending air-conditioned space from an air-conditioned building to an external area that is not covered by a ceiling, comprising:
enclosing the external area with a fence that prevents airflow underneath the fence; and
discharging cooled air at a temperature colder than ambient temperature into the enclosed external area at a displacement air velocity.

40. The method according to claim 39, wherein
the enclosing includes deploying of inflatable ventilated wall.

41. The method according to claim 40, wherein
the inflatable ventilated wall includes at least one perforated face that includes a plurality of openings that permit air from inside of the inflatable ventilated wall to discharge at the displacement air velocity.

42. The method according to claim 40, wherein
the deploying includes inflating the inflatable ventilated wall with a source of pressurized air.

43. The method according to claim 39, wherein
the discharging the cooled air includes supplying the cooled air into the enclosed external area through a displacement air register from the air-conditioned space.

44. The method according to claim 39, wherein the discharging of the cooled air includes supplying the cooled air into the enclosed external area through a door that connects the air-conditioned space to the external area.

45. (canceled)

46. The method according to claim 39, wherein the cooled air is generated by a cooling device that provides cooled air for air conditioning of the air-conditioned space.

47. The method according to claim 39, wherein the cooled air is generated by a cooling device that it does not provide air for the air conditioning of the air-conditioned space.

48. A system for cooling an outdoor space, comprising:
an air-conditioned enclosed building;
an outdoor space that is not enclosed by a ceiling, adjacent to the air-conditioned enclosed building;
a ventilated wall surrounding the outdoor space and configured to supply cooled air at a temperature colder than ambient air into the outdoor space at a displacement air velocity.

49-51. (canceled)

52. The system according to claim 48, wherein the ventilated wall is made of a soft and/or flexible material.

53. The system according to claim 52, wherein the ventilated wall is inflated with a gas in order to hold its final shape.

54-56. (canceled)
